(19) United States
(12) Patent Application Publication
(10) Pub. No.: US 2026/0167166 A1
(43) Pub. Date: Jun. 18, 2026

(54) System for Controlling a Parking Brake in a Vehicle

(71) Applicant: KB Intellectual Property GmbH &Co. KG, Pullach (DE)

(72) Inventors: Amit Babalal Nahar, Pune (IN); Jeswanth Samayamantula, Avon Lake, OH (US)

(21) Appl. No.: 18/979,856

(22) Filed: Dec. 13, 2024

(51) Int. Cl. B60T 13/68; B60T 8/94

(52) U.S. Cl. CPC B60T 13/683; B60T 8/94; B60T 2270/402; B60T 2270/413

(57) ABSTRACT

A system for controlling a parking brake in a vehicle includes first and second electropneumatic valve modules disposed between a fluid source and a wheel brake on the vehicle. The valve modules include first and second solenoids, respectively, movable between a delivery state allowing fluid flow between supply and delivery ports on the valve module and an exhaust state allowing fluid flow between delivery and exhaust ports on the valve module. A brake controller transmits a first control signal to the first solenoid, the first control signal configured to position the first solenoid in one of the delivery and exhaust states. A secondary control circuit generates, responsive to a first feedback signal indicative of the state of the first solenoid, a second control signal configured to position the second solenoid in one of the delivery and exhaust states.

### BACKGROUND OF THE INVENTION

### a. Field of the Invention

This disclosure relates to a system for controlling a parking brake in a vehicle. In particular, this disclosure relates to a system that enables control of multiple electropneumatic valve modules (a primary valve module and a secondary, or backup, valve module) used to control fluid flow to a brake actuator with a single controller.

### b. Background Art

Conventional vehicles include one or more wheel brakes configured to apply a braking force to one or more wheels on the vehicle. At least some of the wheel brakes are configured to function as a parking or emergency brake. To enable functionality as a parking or emergency brake, the brake actuator for the wheel brake may include a spring that biases the wheel brake to an applied state. Fluid pressure provided to the brake actuator is used to overcome the force of the spring and move the wheel brake to a released state. Fluid flow to and from the brake actuator to release and apply the brake may be controlled using a brake controller and an electropneumatic valve module that provides fluid to, and exhausts fluid from, the brake actuator responsive to signals from the brake controller.

To ensure safe operation of the vehicle and comply with government regulations for the safe operation of the vehicle—particularly for automated or self-driving vehicles—conventional vehicles frequently include primary and secondary, or backup, brake control systems for actuating the parking brake. Therefore, a conventional vehicle may include a primary electropneumatic valve module and a secondary, or backup, electropneumatic valve module that controls fluid flow to and from the brake actuator in the event of a failure of the primary electropneumatic valve module. Conventional vehicles further include primary and secondary brake controllers to control the primary and secondary electropneumatic valve modules, respectively. The use of multiple brake controllers, however, results in relatively high costs for the brake control system.

The inventors herein have recognized a need for a system for controlling a parking brake in a vehicle that will minimize and/or eliminate one or more of the above-identified deficiencies.

### BRIEF SUMMARY OF THE INVENTION

This disclosure relates to a system for controlling a parking brake in a vehicle. In particular, this disclosure relates to a system that enables control of multiple electropneumatic valve modules (a primary valve module and a secondary, or backup, valve module) used to control fluid flow to a brake actuator with a single controller.

An embodiment of a system for controlling a parking brake in a vehicle includes a first electropneumatic valve module disposed between a fluid source and a wheel brake on the vehicle. The first electropneumatic valve module includes a first solenoid movable between a first solenoid delivery state allowing fluid flow from a supply port on the first electropneumatic valve module to a delivery port on the first electropneumatic valve module and a first solenoid exhaust state allowing fluid flow from the delivery port on the first electropneumatic valve module to an exhaust port on the first electropneumatic valve module. The system further includes a second electropneumatic valve module disposed between the fluid source and the wheel brake. The second electropneumatic valve module includes a second solenoid movable between a second solenoid delivery state allowing fluid flow from a supply port on the second electropneumatic valve module to a delivery port on the second electropneumatic valve module and a second solenoid exhaust state allowing fluid flow from the delivery port on the second electropneumatic valve module to an exhaust port on the second electropneumatic valve module. The system further includes a brake controller configured to transmit a first control signal to the first solenoid. The first control signal is configured to position the first solenoid in one of the first solenoid delivery state and the first solenoid exhaust state. The system further includes a secondary control circuit configured to generate, responsive to a first feedback signal from the first electropneumatic valve module indicative of whether the first solenoid is in the first solenoid delivery state or the first solenoid exhaust state, a second control signal. The second control signal is configured to position the second solenoid in one of the second solenoid delivery state and the second solenoid exhaust state.

Another embodiment of a system for controlling a parking brake in a vehicle includes a first electropneumatic valve module disposed between a fluid source and a wheel brake on the vehicle. The first electropneumatic valve module includes a first solenoid movable between a first solenoid delivery state allowing fluid flow from a supply port on the first electropneumatic valve module to a delivery port on the first electropneumatic valve module and a first solenoid exhaust state allowing fluid flow from the delivery port on the first electropneumatic valve module to an exhaust port on the first electropneumatic valve module. The system further includes a second electropneumatic valve module disposed between the fluid source and the wheel brake. The second electropneumatic valve module includes a second solenoid movable between a second solenoid delivery state allowing fluid flow from a supply port on the second electropneumatic valve module to a delivery port on the second electropneumatic valve module and a second solenoid exhaust state allowing fluid flow from the delivery port on the second electropneumatic valve module to an exhaust port on the second electropneumatic valve module. The system further includes a brake controller configured to transmit a first control signal to the first solenoid. The first control signal is configured to position the first solenoid in one of the first solenoid delivery state and the first solenoid exhaust state. The system further includes means for generating, responsive to a first feedback signal from the first electropneumatic valve module indicative of whether the first solenoid is in the first solenoid delivery state or the first solenoid exhaust state, a second control signal. The second control signal is configured to position the second solenoid in one of the second solenoid delivery state and the second solenoid exhaust state.

A system for controlling a parking brake in a vehicle in accordance with the teachings disclosed herein is advantageous relative to conventional systems. In particular, the inventive system enables control of primary and secondary, or backup, electropneumatic valve modules used to control fluid flow to a brake actuator using a single brake controller and a relatively simple secondary control circuit thereby eliminating the need for separate brake controllers for each electropneumatic valve module and significantly reducing the cost of the brake control system.

The foregoing and other aspects, features, details, utilities, and advantages of the present teachings will be apparent from reading the following description and claims, and from reviewing the accompanying drawings.

### BRIEF DESCRIPTION OF THE DRAWINGS

FIG. 1 is a diagrammatic view of one embodiment of a system for controlling a parking brake in a vehicle in accordance with the teachings set forth herein.

FIG. 2 is a diagrammatic view of another embodiment of a system for controlling a parking brake in a vehicle in accordance with the teachings set forth herein.

FIG. 3 is a diagrammatic view of another embodiment of a system for controlling a parking brake in a vehicle in accordance with the teachings set forth herein.

FIG. 4 is a diagrammatic view of another embodiment of a system for controlling a parking brake in a vehicle in accordance with the teachings set forth herein.

FIG. 5 is a flowchart diagram illustrating one embodiment of a method for controlling a parking brake in a vehicle in accordance with the teachings set forth herein.

### DETAILED DESCRIPTION OF THE INVENTION

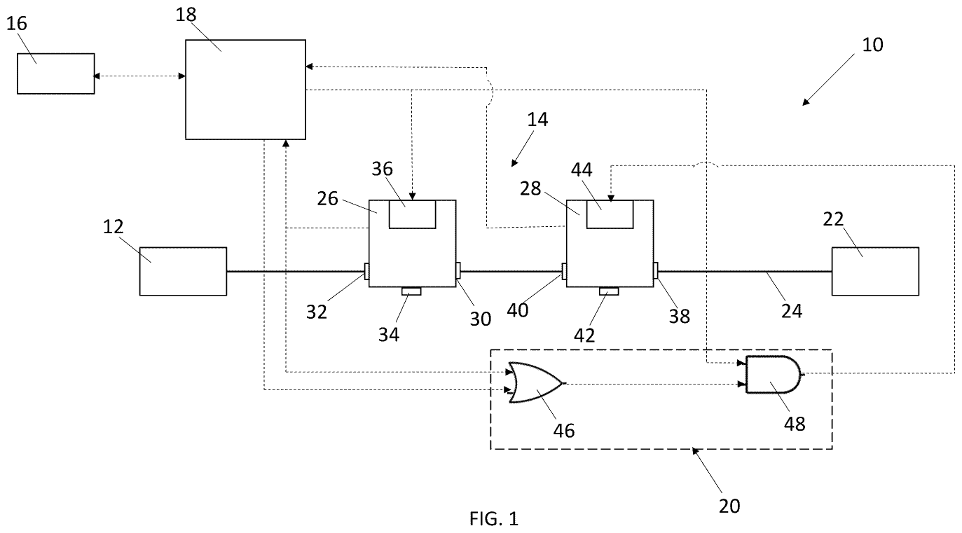

Referring now to the drawings wherein like reference numerals are used to identify identical components in the various views, FIG. 1 illustrates one embodiment of a system 10 for controlling a parking brake in a vehicle. System 10 is particularly configured for use with vehicles having a high level of driving automation and, in particular, vehicles having Level 4(L4 ) automation as defined by the Society of Automotive Engineers (SAE). It should be understood, however, that system 10 may be used with vehicles having varying levels of automation. System 10 is also particularly configured for use with a commercial vehicle and, in particular, a combination vehicle including a towing or power unit (or tractor) and one or more towed units (or trailers). It should be understood, however, that system 10 may be configured for use with other commercial and non-commercial vehicles. System 10 includes one or more wheel brakes 12, a fluid circuit 14, an operator interface 16, a brake controller 18, and means, such as secondary control circuit 20, for generating a control signal used to control one or more components of fluid circuit 14 as described hereinbelow.

Wheel brakes 12 are configured to apply a braking force to one or more wheels on the vehicle. Wheel brakes 12 may be located at each end of an axle on the vehicle. Wheel brakes 12 may comprise disc brakes in which a carrier supports brake pads on opposite sides of a rotor rotating with the wheel and an actuator causes, responsive to fluid pressure delivered by fluid circuit 14, movement of a caliper relative to the carrier to move the brake pads into and out of engagement with the rotor. Alternatively, wheel brakes 12 may comprise drum brakes in which an actuator such as a cam or piston causes, responsive to fluid pressure delivered by fluid circuit 14, movement of one or more brake shoes into engagement with a braking surface in a brake drum rotating with the wheel. Wheel brakes 12 may be configured to function as both a service brake for applying service braking while the vehicle is an active state and as a parking brake for applying parking or emergency braking while the vehicle is an active or inactive state. To enable functionality as a service brake, the brake actuator for wheel brake 12 may include a member (e.g., a pushrod connected to a diaphragm) that is moved in one direction responsive to the presence of fluid pressure to move the wheel brake 12 to an applied state and in the opposite direction responsive to the absence of fluid pressure to move the wheel brake 12 to a released state. To enable functionality as a parking brake, the brake actuator for wheel brake 12 may include a spring that biases the wheel brake 12 to an applied state. Fluid pressure provided to the brake actuator is used to overcome the force of the spring and move the wheel brake 12 to a released state.

Fluid circuit 14 generates fluid pressure within system 10 and controls the delivery of fluid pressure to the actuator of each wheel brake 12 to apply or release either or both of a service brake and a parking brake depending on the configuration of the wheel brake 12. Circuit 14 may include components for generating and storing pressurized fluid including one or more fluid sources 22 and components for routing and delivering fluid pressure to wheel brakes 12 including fluid conduits 24 and various devices for controlling the flow of fluid within circuit 14 including electropneumatic valve modules 26, 28. It should be understood that fluid circuit 14 may include a variety of additional valves and valve modules depending on the configuration of the vehicle including, for example, a foot brake module, modulator valves, relay valves, quick release valves and in certain commercial vehicles, a tractor protection valve, a trailer control valve, a dash control valve and a trailer parking control valve.

Fluid source 22 stores compressed fluid for use in applying service brakes and releasing parking or emergency brakes in wheel brakes 12. Fluid source 22 may receive compressed fluid from a compressor (not shown) that draws in air and compresses the air and an air treatment module (not shown) that collects and removes solid, liquid and vapor contaminants from the pressurized fluid generated by the compressor prior to delivery to fluid source 22. Although a single fluid source 22 is shown in the illustrated embodiment, it should be understood that fluid circuit 14 may include multiple fluid sources.

Fluid conduits 24 are used to transport fluid between fluid source 22, electropneumatic valve modules 26, 28 and wheel brakes 12. Conduits 24 may be made from conventional metals and/or plastics and have connectors at either end configured to join the conduits 24 to corresponding components of fluid circuit 14.

Electropneumatic valve module 26 is provided to control delivery of fluid pressure to, and exhaustion of fluid pressure from, wheel brakes 12 for use in controlling the release and application of the parking brake in wheel brake 12. Module 26 includes one or more relay valves that deliver fluid pressure from fluid source 22 to wheel brakes 12 or exhaust fluid pressure from wheel brakes 12 responsive to a control pressure. The relay valves increase the volume of fluid, and therefore the flow, at which fluid is delivered to, and exhausted from, wheel brakes 12 in order to reduce lag times between the commanded and actual application and release of wheel brakes 12. The relay valve in module 26 defines a supply port 30, a delivery port 32 and an exhaust port 34. In the illustrated embodiment, supply port 30 of module 26 is coupled to module 28, delivery port 32 of module 26 is coupled to wheel brake 12 and exhaust port 34 is uncoupled. Module 26 further includes a solenoid 36 configured to regulate the control pressure and, therefore, control the operation of the relay valves in module 26. The solenoid 36 is movable between a solenoid delivery state allowing fluid flow from supply port 30 to delivery port 32 and a solenoid exhaust state allowing fluid flow from delivery port 32 to exhaust port 34. An electronic control unit in module 26 controls the operation of solenoid 36 responsive to control signals from controller 18. The electronic control unit also generates a feedback signal indicative of the operating state of solenoid 36 and, in particular, whether solenoid 36 is in the solenoid delivery state or solenoid exhaust state. The electronic control unit may also process signals from pressure sensors within module 26 and from wheel speed sensors and brake lining wear sensors associated with corresponding wheels and wheel brakes 12, respectively, and may generate and transmit signals indicative of fluid pressure, wheel speed and brake lining wear to controller 18. Module 26 may transmit signals to and/or receive signals from controller 18 and second control circuit 20 indirectly over a conventional vehicle communications bus implementing a communications network such as a controller area network (CAN) or local interconnect network (LIN) or over a vehicle power line through power line communication (PLC) in accordance with various industry standard protocols including by not limited to SAE J1939, SAEJ1922, and SAE J2497 or using a proprietary protocol. Alternatively, module 26 may transmit signals to and/or receive signals from controller 18 through dedicated electrical connections with controller 18.

Electropneumatic valve module 28 is also provided to control delivery of fluid pressure to, and exhaustion of fluid pressure from, wheel brakes 12 for use in controlling the release and application of the parking brake in wheel brake 12 and may act as a secondary, or backup, valve module to valve module 26 in the event of a failure of solenoid 36 in valve module 26. Module 28 defines a supply port 38, a delivery port 40 and an exhaust port 42. Supply port 38 is coupled to fluid source 22, delivery port 40 is coupled to supply port 30 of module 26 and exhaust port 42 is uncoupled. Module 28 further includes a solenoid 44 configured to control the operation of the valve module 28. The solenoid 44 is movable between a solenoid delivery state allowing fluid flow from supply port 38 to delivery port 40 and a solenoid exhaust state allowing fluid flow from delivery port 40 to exhaust port 42. An electronic control unit in module 28 controls the operation of solenoid 44 responsive to control signals from secondary control circuit 20. The electronic control unit also generates a feedback signal indicative of the operating state of solenoid 44 and, in particular, whether solenoid 44 is in the solenoid delivery state or solenoid exhaust state. The electronic control unit may also process signals from pressure sensors within module 28 and may generate and transmit signals indicative of fluid pressure to controller 18. Module 28 may again transmit signals to and/or receive signals from controller 18 and secondary control circuit 20 indirectly over a conventional vehicle communications bus, over a vehicle power line, or through dedicated electrical connections with controller 18 as described above in connection with module 26.

Operator interface 16 provides an interface between the vehicle operator and system 10 through which the operator can, for example, receive information about the operation of system 10. Interface 16 may be mounted within the cabin of the vehicle and, in particular, on the dashboard of the vehicle. Interface 16 may assume various forms. Interface 16 may, for example, include a screen display (e.g., a touch screen display) with a graphical user interface (GUI). Interface 16 may include one or more handles, push buttons or switches through which an operator may input commands to the vehicle. Interface 16 may also include light emitters, such as light emitting diodes, sound emitters, such as a speaker, and/or haptic actuators to output visual, audio and/or haptic messages (e.g., warnings or alerts) to the vehicle operator. In the case of visual messages, different information can be conveyed through differences in color, differences in intensity, differences in the number of lights, and differences in the pattern of activation of the lights. In the case of audio messages, different information can be conveyed through differences in the type of sound generated, differences in volume and differences in the pattern of sounds. In the case of haptic messages, different information can be conveyed through differences in the length, intensity, or pattern of vibration.

Brake controller 18 controls solenoid 36 in module 26 to control the parking brake in wheel brake 12. Controller 18 may also control solenoid 44 in module 28 as described hereinbelow. Controller 18 may comprise a programmable microprocessor or microcontroller or any other programmable platform such as a field programmable gate array (FGPA) or may comprise an application specific integrated circuit (ASIC). Controller 18 may include a memory and a central processing unit (CPU). Controller 18 may also include an input/output (I/O) interface including a plurality of input/output pins or terminals through which controller 18 may receive a plurality of input signals and transmit a plurality of output signals. Controller 18 may, for example, receive input signals from modules 26, 28 (including feedback signals indicative of the state of solenoids 36, 44), operator interface 16, and systems on the vehicle requesting emergency braking. Controller 18 may, for example, transmit output signals to modules 26 and secondary control circuit 20 (including control signals configured to actuate solenoids 36, 44), operator interface 16 or other systems on the vehicle needing to know the status of wheel brake 12. Controller 18 may be configured to output a control signal for solenoid 36 of module 26 on an analog pin of controller 18.

Secondary control circuit 20 provides a means for generating a control signal used to control solenoid 44 in module 28. Circuit 20 enables control of the parking brake in wheel brake 12 in the event of a failure of solenoid 36 in module 26. Circuit 20 also allows controller 18 to control solenoid 44 in module 28. Circuit 20 may comprise an application-specific integrated circuit including logic gates 46, 48. In the illustrated embodiment, circuit 20 is disposed outside of brake controller 18. In other embodiments, however, circuit 20 may be embedded within controller 18. Because secondary control circuit 20 is an analog circuit, logic gates 46, 48 may include comparator circuits with hysteresis (i.e., a Schmitt trigger) in the form of a comparator or differential amplifier at each input to the logic gate 46, 48. Alternatively, logic gates 46, 48 may be formed as analog logic gates or circuit 20 may include digital to analog and analog to digital converters as needed.

Logic gate 46 comprise an OR logic gate in the illustrated embodiment and generates an output signal having a high logic level if any input signal has a high logic level and generates an output signal having a low logic level otherwise. Logic gate 46 generates an output signal responsive to a feedback signal from the electronic control unit in module 26 indicative of whether solenoid 36 is in a delivery state or exhaust state and a bypass signal from controller 18. In the illustrated embodiment, the feedback signal assumes high logic level when solenoid 36 is in the delivery state and a low logic level when solenoid 36 is in the exhaust state. The bypass signal is used by controller 18 to independently control solenoid 44 in module 28. In particular, when controller 18 wants to move solenoid 44 to an exhaust state, controller 18 may transmit a bypass signal to logic gate 46 having a high logic level.

Logic gate 48 comprises an AND logic gate in the illustrated embodiment and generates an output signal having a high logic level if all input signals have a high logic level and generates a low logic level otherwise. Logic gate 48 generates a control signal for solenoid 44 in module 28 responsive to the control signal from controller 18 and the output signal of logic gate 46. When controller 18 receives a command to apply the parking brake, controller 18 generates a control signal having a high logic level and transmits the control signal to solenoid 36 of module 26 and logic gate 46 of secondary control circuit 20. If solenoid 36 in module 26 is operating properly and moves to an exhaust state allowing fluid flow between the delivery and exhaust ports 32, 34 on module 26, the feedback signal generated by the electronic control unit in module 26 will assume a low logic level. As a result, logic gate 46 will only generate an output signal having a high logic level and, consequently, logic gate 48 will only generate a control signal for solenoid 44 of module 28 having a high logic level if controller 18 generates a bypass signal having a high logic level. If solenoid 36 in module 26 is not operating properly and does not move to the exhaust state allowing fluid flow between the delivery and exhaust ports 32, 34 on module 26, the feedback signal generated by the electronic control unit in module 26 will assume a high logic level. As a result, logic gate 46 will generate an output signal having a high logic level regardless of the logic level of the bypass signal and logic gate 48 will generate a control signal for solenoid 44 of module 28 having a high logic level to move solenoid 44 from a delivery state to an exhaust state allowing fluid flow between the delivery and exhaust ports 40, 42 on module 28. Because delivery port 40 on module 28 is coupled the supply port 30 on module 26, the drop in pressure at delivery port 40 will cause a corresponding drop in pressure at the supply port 30 on module 26 allowing fluid flow between delivery and exhaust ports 32, 34 on module 26. Thereafter, the parking brake implemented in wheel brake 12 must be manually released.

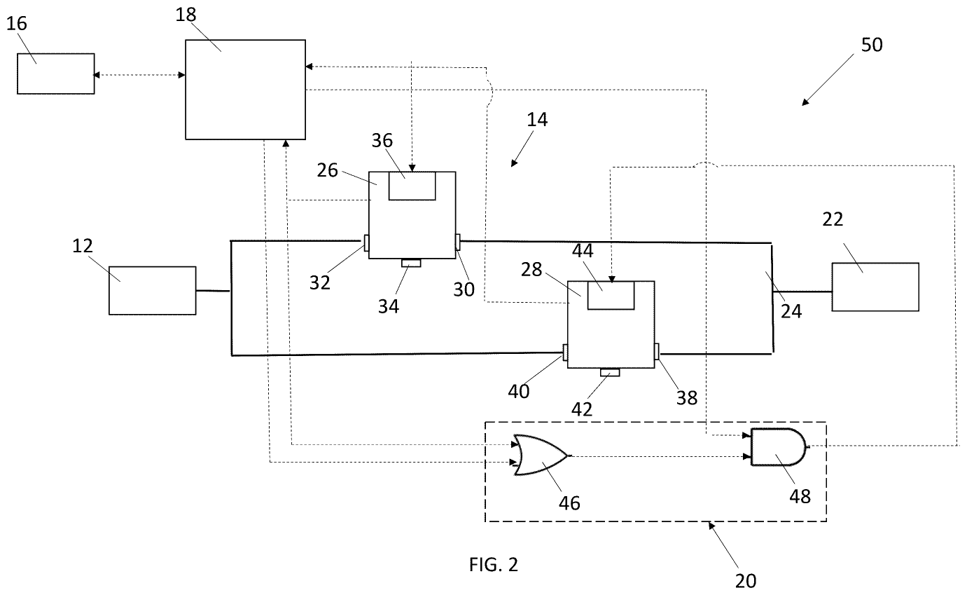

Referring now to FIG. 2, another embodiment of a system 50 for controlling a parking brake in a vehicle is illustrated. System 50 is similar to system 10 and like components in systems 10 and 50 will use the same reference numbers and a description of those components may be found hereinabove. System 50 differs from system 10 in that electropneumatic valve modules 26, 28 are arranged in parallel between wheel brake 12 and fluid source 22 in system 50 as opposed to in series as in system 10. Therefore, the supply ports 30, 38 of both modules 26, 28 are coupled to fluid source 22 while the delivery ports 32, 40 of both modules 26, 28 are coupled to wheel brake 12. In system 50, module 28 preferably has a higher exhaust rate or capacity than module 26. System 50 further differs from system 10 in that, in the event of a failure of the solenoid 36 in module 26 and application of the parking brake through secondary control circuit 20 and module 28, the parking brake does not require manual release and can instead be released by brake controller 18 by adjusting the logic level of the control signal from controller 18.

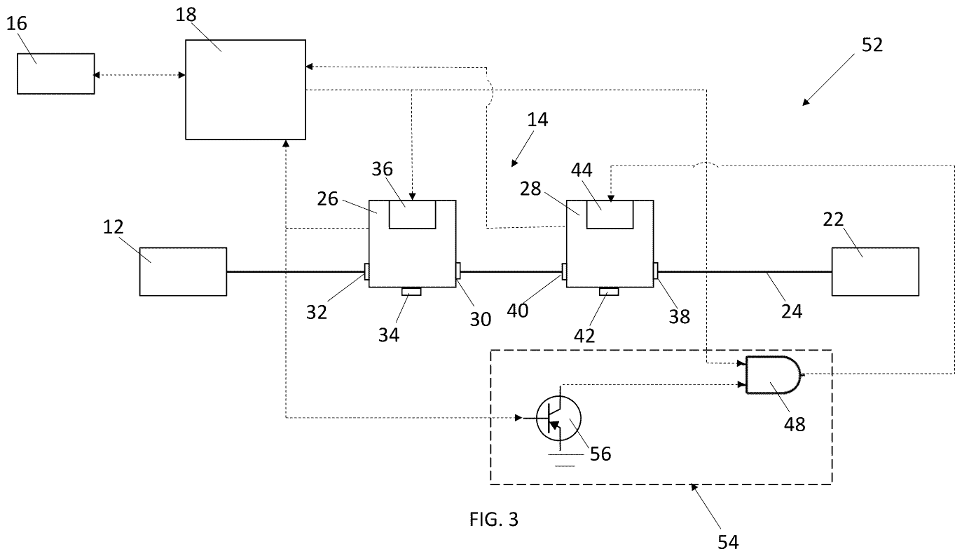

Referring now to FIG. 3, another embodiment of a system 52 for controlling a parking brake in a vehicle is illustrated. System 52 is similar to system 10 and like components in systems 10 and 52 will use the same reference numbers and a description of those components may be found hereinabove. System 52 differs from system 10 in that system 52 includes a different secondary control circuit 54 relative to secondary control circuit 20 in system 10. Secondary control circuit 54 again provides a means for generating a control signal for solenoid 44 in module 28. Secondary control circuit 54, however, includes a switch 56 that generates an output signal responsive to the feedback signal from module 26 instead of OR gate 46 found in secondary control circuit 20 of system 10. In the illustrated embodiment, switch 56 comprises a bipolar junction transistor having a base coupled to the electronic control unit in module 26 and configured to receive the feedback signal from module 26, an emitter coupled to ground and a collector coupled to an input terminal of logic gate 48 and configured to provide an output signal to logic gate 48 responsive to the feedback signal. System 52 operates in substantially the same manner as system 10, but controller 18 cannot independently control solenoid 44 in module 28.

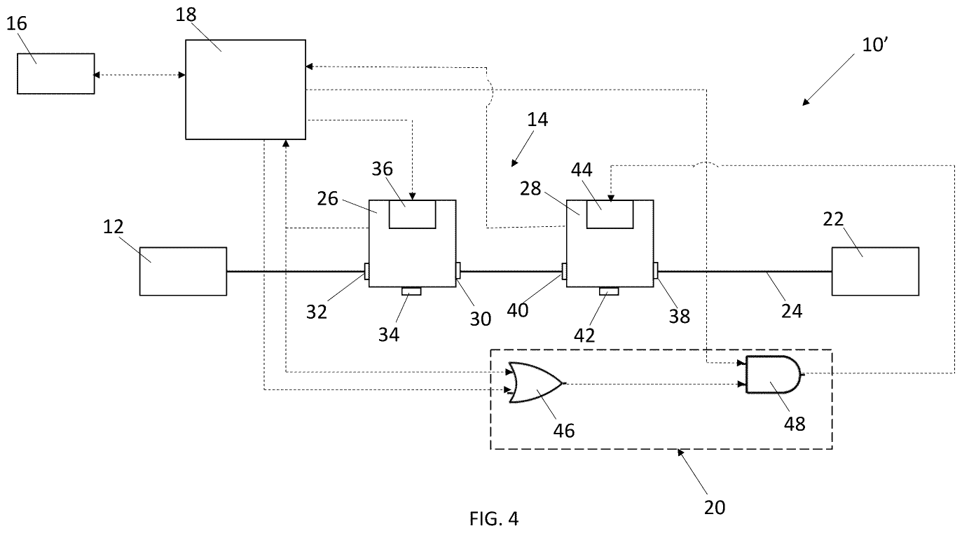

Referring now to FIG. 4, another embodiment of a system 10′ for controlling a parking brake in a vehicle is illustrated. System 10′ is substantially similar to system 10. System 10′ differs from system 10 in that brake controller 18 generates and transmits an additional, separate control signal to secondary control circuit 20 instead of using the same control signal used to actuate solenoid 36 in module 26. In system 10′, controller 18 generates the additional control signal for secondary control circuit 20 on another terminal or pin of controller 18 and transmits the control signal to logic gate 48. Logic gate 48 then generate the control signal for solenoid 44 in module 28 responsive to the output signal of logic gate 46 and the additional control signal from controller 18. Because the embodiment in FIG. 4 uses separate control signals from controller 18 to actuate solenoids 36, 44 in modules 26, 28, respectively, controller 18 can—in the absence of a failure of solenoid 36 in module 26—balance the overall load on each solenoid 36, 44 by actuating solenoids 36, 44 on an alternating basis or another basis intended to distribute the workload among solenoids 36, 44 and thereby extend the life of solenoids 36, 44 and modules 26, 28. When controller 18 wants to actuate solenoid 44 in module 28 instead of solenoid 36 in module 26—as opposed to when a prior attempt to actuate solenoid 36 in module 26 has failed—both the control signal generated by controller 18 and provided to logic gate 48 and the bypass signal generated by controller 18 and provided to logic gate 46 must assume a relatively high logic level. When solenoid 36 in module 26 has failed, controller 18 will detect the failure through the feedback signal from module 26 and cause the additional control signal to assume a high logic level. Because the feedback signal will also have a high logic level, the control signal output by logic gate 48 will also a high logic level. Although FIG. 4 illustrates a variation of system 10 in which brake controller 18 generates a separate control signal for secondary control circuit 20, it should be understood that systems 50, 52 could be modified in a similar way with brake controller 18 generating and transmitting an additional, separate control signal to logic gate 48 in systems 50, 52 instead of using the same control signal used to actuate solenoid 36 in module 26. Because a separate control signal from controller 18 is used in system 10′ (and any similarly modified version of system 50), it should be understood that the bypass signal from controller 18 could be eliminated and secondary control circuit 20 could be simplified by, for example, using a single OR logic gate responsive to the feedback signal and the separate control signal from controller 18 in place of logic gates 46, 48. The configuration of secondary control circuit 20 shown in FIGS. 1, 2 and 4, however, prevents any unintended actuation of solenoid 44 in electropneumatic valve module 28 that could result from a failure in generation of the feedback signal from electropneumatic valve module 26 or the separate control signal from controller 18.

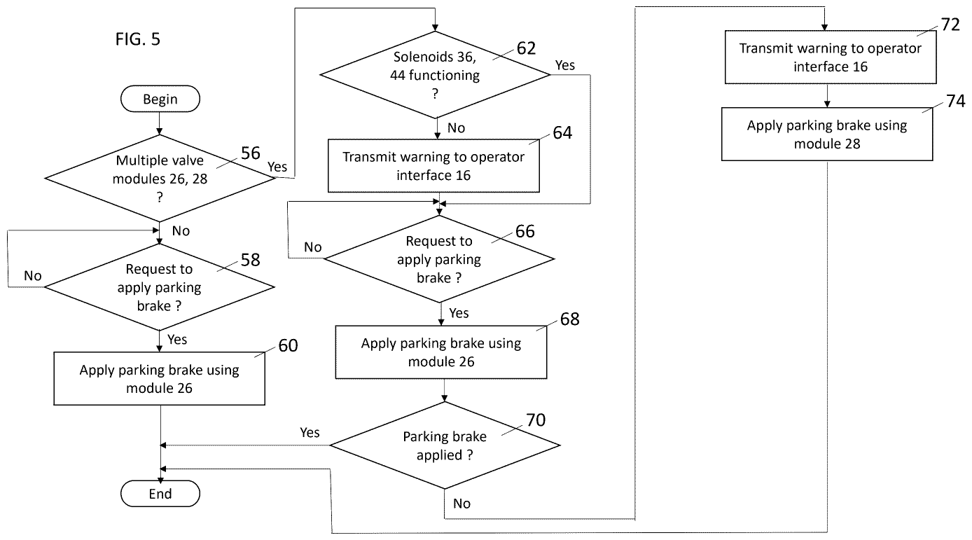

Referring now to FIG. 5, controller 18 may be configured with appropriate programming instructions (i.e., software or a computer program) to implement several steps in a method for controlling a parking brake in vehicle 10 as described below. The instructions or computer program may be encoded on a non-transitory computer storage medium such as a memory within, or accessible by, controller 18. The method may begin with the step 56 of determining whether the brake control system of the vehicle is configured with primary and secondary electromagnetic valve modules 26, 28 for use in controlling the parking brake (i.e., whether the braking system includes a system such as system 10, 50, or 52). If the brake control system of the vehicle is not configured with primary and secondary electromagnetic valve modules 26, 28, controller 18 may, in steps 58-60, receive a request to apply the parking and, in response, generate and transmit a control signal to the solenoid 36 in the primary (only) electropneumatic valve module 26 to move the solenoid 36 from the solenoid delivery state to the solenoid exhaust state allowing fluid flow from the delivery port 32 on module 26 to the exhaust port 34 on module 26 to exhaust the parking brake chamber of the brake actuator.

If the brake control system of the vehicle is configured with primary and secondary electromagnetic valve modules 26, 28, controller 18 may proceed with step 62 in which controller 18 determines whether the solenoids 36, 44 in modules 26, 28 are operating as intended. Controller 18 may, for example, generate and transmit control signals to the solenoids 36, 44 in each module 26, 28 in systems 10, 54 (or to at least the solenoid 36 in module 26 in system 52) to move each solenoid 36, 44, from one of the solenoid delivery state and solenoid exhaust state to the other state and monitor the corresponding feedback signals to verify that the solenoid has assumed the desired state. If either solenoid 36, 44 has not assumed the desired state, controller 18 may, in step 64, generate and transmit a warning signal to operator interface 16 to alert the vehicle operator that a solenoid 36, 44 is malfunctioning.

The method may continue with the step 66 of receiving a request to apply the parking brake. This request may come from the vehicle operator through, for example, operator interface 16 or from an advanced drive assistance system on the vehicle. Once a request to apply the emergency brake is received, controller 18 may, in step 68, generate and transmit a control signal to solenoid 36 in module 26 to move solenoid 36 from the solenoid delivery state to the solenoid exhaust state allowing fluid flow from the delivery port 32 of module 26 to the exhaust port 34 of module 26 to exhaust fluid from the brake chamber in the brake actuator for wheel brake 12.

In step 70, controller 18 determines whether the parking brake has been applied. Controller 18 may make this determination responsive to the feedback signal from the electronic control unit in module 26. If the feedback signal indicates that solenoid 36 is in the solenoid exhaust state, controller 18 determines that the parking brake has been applied. If the feedback signal indicates that solenoid 36 remains in the solenoid delivery state, controller 18 determines that the parking brake has not been applied.

If controller 18 determines in step 70 that the parking brake has been applied, no further action is required and the method ends. If controller 18, determines in step 70 that the emergency brake has not been applied, controller 18 may, in step 72, again generate and transmit a warning signal to operator interface 16 to alert the vehicle operator that solenoid 36 is malfunctioning. If the parking brake has not been applied in response to the control signal generated in step 68, secondary control circuit 20 or 54 will, in step 74, automatically generate and transmit, without further action by controller 18, a control signal to solenoid 44 in module 28 configured to move solenoid 44 from a solenoid delivery state to a solenoid exhaust state. In particular, the feedback signal will assume a high logic level configured to cause logic gate 46 in systems 10, 50 or switch 56 in system 52 to generate an output signal having a high logic level. Because the control signal for solenoid 36 of module 26 also has a high logic level and acts as the other input to logic gate 48, logic gate 48 will generate a control signal having a high logic level configured to move solenoid 44 from the solenoid delivery state to the solenoid exhaust state. This action will exhaust fluid from the brake chambers of the brake actuator for wheel brake 12 directly in the case of system 50 or indirectly in the case of systems 10, 52 by allowing fluid to flow from the delivery port 40 of module 28 to the exhaust port 42 of module 28 despite the malfunction of solenoid 36 in module 26.

A system 10, 10′, 50 or 52 for controlling a parking brake in a vehicle in accordance with the teachings disclosed herein is advantageous relative to conventional systems. In particular, the inventive system 10, 10′, 50 or 52 enables control of primary and secondary, or backup, electropneumatic valve modules 26, 28 used to control fluid flow to a brake actuator using a single controller 18 and a relatively simple secondary control circuit 20 or 54 thereby eliminating the need for separate controllers for each electropneumatic valve module 26, 28 and significantly reducing the cost of the brake control system.

While the invention has been shown and described with reference to one or more particular embodiments thereof, it will be understood by those of skill in the art that various changes and modifications can be made without departing from the spirit and scope of the invention.

What is claimed is:

1. A system for controlling a parking brake in a vehicle, comprising:
a first electropneumatic valve module disposed between a fluid source and a wheel brake on the vehicle, the first electropneumatic valve module including a first solenoid movable between a first solenoid delivery state allowing fluid flow from a supply port on the first electropneumatic valve module to a delivery port on the first electropneumatic valve module and a first solenoid exhaust state allowing fluid flow from the delivery port on the first electropneumatic valve module to an exhaust port on the first electropneumatic valve module;
a second electropneumatic valve module disposed between the fluid source and the wheel brake, the second electropneumatic valve module including a second solenoid movable between a second solenoid delivery state allowing fluid flow from a supply port on the second electropneumatic valve module to a delivery port on the second electropneumatic valve module and a second solenoid exhaust state allowing fluid flow from the delivery port on the second electropneumatic valve module to an exhaust port on the second electropneumatic valve module;
a brake controller configured to transmit a first control signal to the first solenoid, the first control signal configured to position the first solenoid in one of the first solenoid delivery state and the first solenoid exhaust state; and,
a secondary control circuit configured to generate, responsive to a first feedback signal from the first electropneumatic valve module indicative of whether the first solenoid is in the first solenoid delivery state or the first solenoid exhaust state, a second control signal, the second control signal configured to position the second solenoid in one of the second solenoid delivery state and the second solenoid exhaust state.

2. The system of claim 1 wherein the supply port of the second electropneumatic valve module is in fluid communication with the fluid source, the delivery port of the second electropneumatic valve module is in fluid communication with the supply port of the first electropneumatic valve module and the delivery port of the first electropneumatic valve module is in fluid communication with the wheel brake.

3. The system of claim 1 wherein the supply port of the first electropneumatic valve module and the supply port of the second electropneumatic valve module are both in fluid communication with the fluid source and the delivery port of the first electropneumatic valve module and the delivery port of the second electropneumatic valve module are both in fluid communication with the wheel brake.

4. The system of claim 1 wherein the secondary control circuit generates the second control signal responsive the first feedback signal, a bypass signal received from the brake controller and the first control signal.

5. The system of claim 4 wherein the secondary control circuit includes:
a first logic gate that generates an output signal responsive to the first feedback signal and the bypass signal; and,
a second logic gate that generates the second control signal responsive to the output signal of the first logic gate and the first control signal.

6. The system of claim 1 wherein the secondary control circuit generates the second control signal responsive the first feedback signal, a bypass signal received from the brake controller and a third control signal received from the brake controller.

7. The system of claim 6 wherein the secondary control circuit includes:
a first logic gate that generates an output signal responsive to the first feedback signal and the bypass signal; and,
a second logic gate that generates the second control signal responsive to the output signal of the first logic gate and the third control signal.

8. The system of claim 1 wherein the secondary control circuit includes:
a switch that generates an output signal responsive to the first feedback signal; and,
a first logic gate that generates the second control signal responsive to the output signal of the switch and the first control signal.

9. The system of claim 8 wherein the first logic gate comprises an AND logic gate.

10. The system of claim 1 wherein the brake controller is configured to determine whether the first solenoid is in the first solenoid delivery state or the first solenoid exhaust state responsive to the first feedback signal and to determine whether the second solenoid is in the second solenoid delivery state or the second solenoid exhaust state responsive to a second feedback signal from the second electropneumatic valve module indicative of whether the second solenoid is in the second solenoid delivery state or the second solenoid exhaust state.

11. A system for controlling a parking brake in a vehicle, comprising:
a first electropneumatic valve module disposed between a fluid source and a wheel brake on the vehicle, the first electropneumatic valve module including a first solenoid movable between a first solenoid delivery state allowing fluid flow from a supply port on the first electropneumatic valve module to a delivery port on the first electropneumatic valve module and a first solenoid exhaust state allowing fluid flow from the delivery port on the first electropneumatic valve module to an exhaust port on the first electropneumatic valve module;
a second electropneumatic valve module disposed between the fluid source and the wheel brake, the second electropneumatic valve module including a second solenoid movable between a second solenoid delivery state allowing fluid flow from a supply port on the second electropneumatic valve module to a delivery port on the second electropneumatic valve module and a second solenoid exhaust state allowing fluid flow from the delivery port on the second electropneumatic valve module to an exhaust port on the second electropneumatic valve module;
a brake controller configured to transmit a first control signal to the first solenoid, the first control signal configured to position the first solenoid in one of the first solenoid delivery state and the first solenoid exhaust state; and,
means for generating, responsive to a first feedback signal from the first electropneumatic valve module indicative of whether the first solenoid is in the first solenoid delivery state or the first solenoid exhaust state, a second control signal, the second control signal configured to position the second solenoid in one of the second solenoid delivery state and the second solenoid exhaust state.

12. The system of claim 11 wherein the supply port of the second electropneumatic valve module is in fluid communication with the fluid source, the delivery port of the second electropneumatic valve module is in fluid communication with the supply port of the first electropneumatic valve module and the delivery port of the first electropneumatic valve module is in fluid communication with the wheel brake.

13. The system of claim 11 wherein the supply port of the first electropneumatic valve module and the supply port of the second electropneumatic valve module are both in fluid communication with the fluid source and the delivery port of the first electropneumatic valve module and the delivery port of the second electropneumatic valve module are both in fluid communication with the wheel brake.

14. The system of claim 11 wherein the means for generating generates the second control signal responsive to the first feedback signal, a bypass signal received from the brake controller and the first control signal.

15. The system of claim 14 wherein the means for generating includes:
a first logic gate that generates an output signal responsive to the first feedback signal and the bypass signal; and,
a second logic gate that generates the second control signal responsive to the output signal of the first logic gate and the first control signal.

16. The system of claim 11 wherein the means for generating generates the second control signal responsive the first feedback signal, a bypass signal received from the brake controller and a third control signal received from the brake controller.

17. The system of claim 16 wherein the means for generating includes:
a first logic gate that generates an output signal responsive to the first feedback signal and the bypass signal; and,
a second logic gate that generates the second control signal responsive to the output signal of the first logic gate and the third control signal.

18. The system of claim 11 wherein the means for generating includes:
a switch that generates an output signal responsive to the first feedback signal; and,
a first logic gate that generates the second control signal responsive to the output signal of the switch and the first control signal.

19. The system of claim 18 wherein the first logic gate comprises an AND logic gate.

20. The system of claim 11 wherein the brake controller is configured to determine whether the first solenoid is in the first solenoid delivery state or the first solenoid exhaust state responsive to the first feedback signal and to determine whether the second solenoid is in the second solenoid delivery state or the second solenoid exhaust state responsive to a second feedback signal from the second electropneumatic valve module indicative of whether the second solenoid is in the second solenoid delivery state or the second solenoid exhaust state.
